(19) United States
(12) Patent Application Publication
(10) Pub. No.: US 2022/0327614 A1
(43) Pub. Date: Oct. 13, 2022

(54) PERSONALIZED AND DYNAMIC FINANCIAL SCORING SYSTEM FOR PROGRESS TRACKING TOWARDS SPECIFIC FINANCING QUALIFICATIONS BASED ON A SPECIFIED PURCHASE TARGET

(71) Applicant: OwnIT Holdings, Inc., Franklin, TN (US)

(72) Inventors: Joel David Byerley, Nashville, TN (US); Samuel Lingo, Nashville, TN (US); Matthew Scott Rigsby, Nashville, TN (US)

(21) Appl. No.: 17/716,417

(22) Filed: Apr. 8, 2022

Related U.S. Application Data
(60) Provisional application No. 63/172,351, filed on Apr. 8, 2021.

(51) Int. Cl. G06Q 40/02

(52) U.S. Cl. CPC G06Q 40/025

(57) ABSTRACT

A finance score determination system for determining a finance score of a consumer. The system includes a raw score determination unit for receiving at least creditworthiness data, consumer related data, and target asset related data to form received data, and processing the received data to determine a raw creditworthiness score, a raw monetary score, and a raw capacity score. The system includes a weighting unit for applying a selected weighted value to the raw scores to form weighted scores and a finance score determination unit for determining the finance score by arithmetically combining the weighted scores.

### RELATED APPLICATION

The present application claims priority to provisional patent application Ser. No. 63/172,351, filed on Apr. 8, 2021, and entitled, Personalized And Dynamic Financial Scoring System For Progress Tracking Towards Specific Financing Qualifications Based On A Specified Purchase Target, the contents of which are herein incorporated by reference.

### BACKGROUND OF THE INVENTION

Currently, when people are seeking financing to purchase a selected item or asset, such as a house, the majority of people do not understand the different factors that can impact a person's ability to qualify for financing for the selected asset. This lack of knowledge typically prevents consumers from being able to track conveniently and practically their ability to qualify for financing over time. Further, it is oftentimes difficult in conventional systems for stakeholders in the financing transactions to engage and interact with the customers prior to initiation of a formal pre-qualification process.

### SUMMARY OF THE INVENTION

The present invention is directed to a financial score determination system for determining a personal finance score of a consumer based on a selected set of input data, including creditworthiness data, consumer related data including cash and income and debt information, and target asset related data including property and loan data. The personal finance score is an indication of the ability of the consumer to purchase or lease the target asset based on a selected set of criteria. The personal finance score is not a static score but rather dynamically changes based on changes in the underlying data.

Additionally, the dynamic finance score remains relevant even after the purchase, lease or rental of property, such as a home, because a user can always set a new target asset goal. As such, the financial score determination system of the present invention allows a consumer to measure and manage a variety of financial aspects of their lives with a target goal in mind. The system is configured to provide information, including a dynamic finance score, regarding the consumer's financial position relative to a target goal. Further, since the system is configured to process input data to determine a finance score associated with the consumer, the system, in one embodiment, does not decline a consumer from pursuing the target asset, but rather indicates the consumer's current ability to acquire the asset.

The present invention is directed to a financial score determination system for determining a finance score of a consumer. The system includes a raw score determination unit for receiving at least creditworthiness data, consumer related data, and target asset related data to form received data, and processing the received data to determine a raw creditworthiness score, a raw monetary score, and a raw capacity score; a weighting unit for applying a selected weighted value to the raw creditworthiness score to form a weighted creditworthiness score, to the raw monetary score to form a weighted monetary score, and to the raw capacity score to form a weighted capacity score; and a finance score determination unit for determining the finance score by arithmetically combining the weighted creditworthiness score, the weighted capacity score and the weighted capacity score.

The creditworthiness data includes credit score information and the raw score determination unit determines the raw creditworthiness score by comparing the credit score information with a threshold credit score of a loan product. The consumer related data includes monetary information, and the raw score determination unit determines the raw monetary score by comparing the monetary information with a threshold monetary value of the loan product. Further, the consumer related data includes income and debt information associated with the consumer, and the raw score determination unit determines the raw capacity score by determining a debt-to-income (DTI) ratio of the consumer and comparing the DTI ratio with a threshold DTI ratio of the loan product.

The selected weighted value associated with the raw monetary score is greater than the selected weighted value associated with the raw creditworthiness score and the selected weighted value associated with the raw capacity score. For example, the selected weighted value associated with the raw creditworthiness score is about equal to the selected weighted value associated with the raw capacity score, and the selected weighted value associated with the raw monetary score is about three times greater than the selected weighted value associated with the raw creditworthiness score and the weighted value associated with the raw capacity score.

The system can also include a user interface unit for generating one or more user interfaces for displaying the finance score and a predefined target score, as well as an optional recommendation unit for providing one or more recommendations to the consumer related to actions to take to reach the predefined target score. The recommendation unit is configured to apply one or more machine learning techniques to at least one of the finance score, the creditworthiness data, the consumer related data, and the target asset related data. The system can also include an optional confidence scoring unit for applying a confidence value to one or more of weighted capacity score, the weighted creditworthiness score, and the weighted monetary score.

The present invention is also directed to a computer-implemented method for determining a finance score of a consumer. The method includes determining a raw creditworthiness score, a raw monetary score, and a raw capacity score based at least on creditworthiness data, consumer related data, and target asset related data received from one or more data sources; applying a selected weighted value to the raw creditworthiness score to form a weighted creditworthiness score, to the raw monetary score to form a weighted monetary score, and to the raw capacity score to form a weighted capacity score; and determining the finance score by arithmetically combining the weighted creditworthiness score, the weighted capacity score and the weighted capacity score.

The creditworthiness data includes credit score information and the raw score determination unit determines the raw creditworthiness score by comparing the credit score information with a threshold credit score of a loan product. The consumer related data includes monetary information, and the raw score determination unit determines the raw monetary score by comparing the monetary information with a threshold monetary value of the loan product. Further, the consumer related data includes income and debt information associated with the consumer, and the raw score determination unit determines the raw capacity score by determining a debt-to-income (DTI) ratio of the consumer and comparing the DTI ratio with a threshold DTI ratio of the loan product.

The selected weighted value associated with the raw monetary score is greater than the selected weighted value associated with the raw creditworthiness score and the selected weighted value associated with the raw capacity score. For example, the selected weighted value associated with the raw creditworthiness score is about equal to the selected weighted value associated with the raw capacity score, and the selected weighted value associated with the raw monetary score is about three times greater than the selected weighted value associated with the raw creditworthiness score and the weighted value associated with the raw capacity score.

The method can also include a user interface unit for generating one or more user interfaces for displaying the finance score and a predefined target score, as well as an optional recommendation unit for providing one or more recommendations to the consumer related to actions to take to reach the predefined target score. The recommendation unit is configured to apply one or more machine learning techniques to at least one of the finance score, the creditworthiness data, the consumer related data, and the target asset related data. The method can also optionally apply a confidence value to one or more of the weighted capacity score, the weighted creditworthiness score, and the weighted monetary score.

The present invention is further related to a non-transitory, computer readable medium comprising computer program instructions tangibly stored on the computer readable medium, wherein the computer program instructions are executable by at least one computer processor to perform a method, the method comprising determining a raw creditworthiness score, a raw monetary score, and a raw capacity score based at least on creditworthiness data, consumer related data, and target asset related data received from one or more data sources; applying a selected weighted value to the raw creditworthiness score to form a weighted creditworthiness score, to the raw monetary score to form a weighted monetary score, and to the raw capacity score to form a weighted capacity score; and determining the finance score by arithmetically combining the weighted creditworthiness score, the weighted capacity score and the weighted capacity score.

The creditworthiness data includes credit score information and the raw score determination unit determines the raw creditworthiness score by comparing the credit score information with a threshold credit score of a loan product. The consumer related data includes monetary information, and the raw score determination unit determines the raw monetary score by comparing the monetary information with a threshold monetary value of the loan product. Further, the consumer related data includes income and debt information associated with the consumer, and the raw score determination unit determines the raw capacity score by determining a debt-to-income (DTI) ratio of the consumer and comparing the DTI ratio with a threshold DTI ratio of the loan product.

The selected weighted value associated with the raw monetary score is greater than the selected weighted value associated with the raw creditworthiness score and the selected weighted value associated with the raw capacity score. For example, the selected weighted value associated with the raw creditworthiness score is about equal to the selected weighted value associated with the raw capacity score, and the selected weighted value associated with the raw monetary score is about three times greater than the selected weighted value associated with the raw creditworthiness score and the weighted value associated with the raw capacity score.

The computer readable medium can also include instructions for generating one or more user interfaces for displaying the finance score and a predefined target score, as well as providing one or more recommendations to the consumer related to actions to take to reach the predefined target score. The computer readable medium can also optionally apply a confidence value to one or more of the weighted capacity score, the weighted creditworthiness score, and the weighted monetary score.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is directed to a financial score determination system according to the teachings of the present invention.

FIG. 2A is a table setting forth raw creditworthiness scores associated or correlated with various ranges of credit scores.

FIG. 2B is a table setting forth raw monetary scores associated or correlated with various cash position ranges.

FIG. 2C is a table setting forth raw capacity scores associated or correlated with various capacity ranges.

FIG. 3 is a schematic diagram of an electronic device and/or associated system suitable for implementing the financial score determination system of the present invention.

### DETAILED DESCRIPTION

In consumer financing, there are generally four major areas or factors of focus for a stakeholder or underwriter, such as a lender or landlord, when determining whether to lend money to a consumer. The factors include the amount of cash in easily accessible accounts held by the consumer, the credit score of the consumer, the debt-to-income (DTI) ratio associated with the consumer (e.g., capacity of the consumer to pay), and if applicable the amount of collateral available to be leveraged by the consumer. The system of the present invention can apply one or more of these factors to generate a financing score associated with the consumer. The financing score can be dynamic and can change over time based on real time changes in the underlying factors comprising the score. The system and method of the present invention thus provides data aggregation and translation, finance score determination, and score visualization services to the consumers, stakeholders or end-users granted access rights by the consumer. The score visualization can include displaying the finance score and the target score to the consumer in any selected format. The scores can be dynamically displayed so as to change colors as the finance score changes.

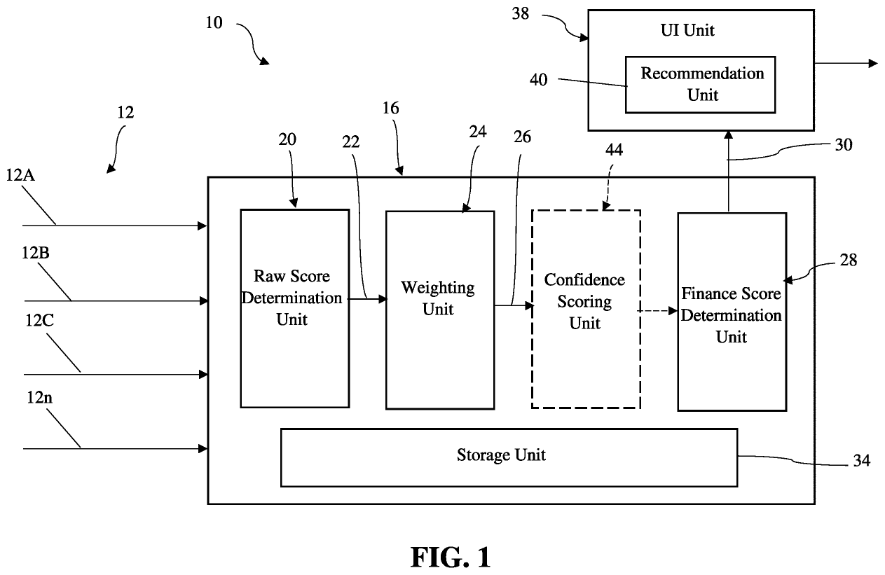

The present invention is thus directed to a finance score determination system 10 for determining a finance score of a consumer. As shown for example in FIG. 1, the finance score determination system 10 receives data from a number of different data sources 12. The system 10 can selectively utilize any combination of the input data from the data sources 12 when determining a finance score. The data sources 12 can include a creditworthiness data source 12A for providing creditworthiness data to the system from a third party source and/or from the consumer. As used herein, the term “creditworthiness data” is intended to include data of any type or source that is indicative of or is related or directed to a consumer's ability to pay a financial obligation in a timely manner, such as for example a loan or other financial type of obligation. Examples of suitable creditworthiness data include credit score data, rent payment history, utility payment history, loan payment history, bank transaction history data, and the like. The credit score is a consumer-driven and target asset agnostic score typically determined by third party companies, such as credit bureaus.

As used herein, the term “consumer” is intended to include an individual, person, a group of people, or an entity that is capable of purchasing, leasing, or renting goods or services, such as a target asset. As used herein, the term “asset” or “target asset” is intended to include any type of tangible or intangible property owned by any type of owner (e.g., individual, corporation, government, legal entity such as a trust, and the like) and regarded as having value associated therewith. Examples of suitable types of assets include real estate and other types of property, including automobiles, planes, land, money, and the like, insurance policies, financial instruments, such as stocks and bonds, and similar or related types of assets. The term is also intended to indicate a desired product or asset to be leased, rented, or acquired by the consumer, such as for example, money associated with a loan product, leasing or renting property, and the like.

The data sources 12 can also include a consumer related data source 12B for providing data of any type that is related to the consumer (e.g., consumer related data). For example, the consumer related data 12B can include personal financial information, loan history information, banking related information including total money or cash in a checking and savings account, investment information, income and salary related information, collateral information, employment history data, and the like. The consumer related data can be input or provided to the finance score determination system 10 directly by the consumer through any suitable interface (e.g., electronic device, APIs, and the like) or can be provided by a database or other storage device that stores the consumer related data. Further, the consumer related data can include money related data indicative of the amount of available cash owned by the consumer, collateral related information indicative of the collateral or assets owned by the consumer, and debt-to-income (DTI) ratio related data, and the like.

The data sources 12 can also provide other types of information to the system. For example, the data source 12C can provide information associated with a target asset, such as property (e.g., real estate) information and/or loan product information to form target asset related data. The real estate information can include information associated with houses, buildings, or land in a specific location or area, and can include, for example, price or sales information of a specific home, median price information associated with a specific area (e.g., zip code), address information, ownership information, and the like. As used herein, the term “loan” or “loan product” is intended to mean the lending or loaning of an asset, such as money, to a borrower (i.e., the consumer) thus incurring a debt obligation. The borrower is required to pay back the loan to the lender according to predefined terms. The loan product terms or information can include property location information, loan qualification information including threshold credit score information, lender information, the amount of money to be borrowed, interest rate information, term information, payment schedule information, closing cost information and the like.

The data source 12n can optionally provide additional types of information, if applicable, such as for example, census information, school district information, real estate tax information, crime statistics information, property insurance information, geography information, consumer provided financial goal information, and the like. One of ordinary skill in the art will readily recognize that the data sources 12 can provide the source data to the finance score determination system 10 by known communication techniques, such as for example over a suitable network. As used herein, the term “finance score” is intended to represent a score or value that is indicative or representative of the current ability of a consumer to rent, lease, or purchase or qualify to rent, lease or purchase a selected target asset based on criteria that is based on data provided by the data sources 12. For example, the target asset can include a property to be purchased, as well as a loan product or other information that is needed to rent, lease or purchase the property, and the score is representative of the ability of the consumer to proceed with the rental, lease or purchase or acquisition of the property (e.g., target asset). The finance score is also related to or associated with a target score. The finance score can be a number, percentage, or any other types of value. As used herein, the term “target score” is intended to include a score or value that is indicative of a threshold ability of the consumer to be able to rent, lease or purchase or qualify to rent, lease or purchase the target asset. According to one embodiment, if the value of the finance score is greater than the value of the target score, then the consumer qualifies to rent, lease or purchase the target asset based on a selected set of criteria, such as the requirements of, for example, the loan product. If the finance score is less than the target score, then the consumer does not yet meet the requirements or criteria to rent, lease or purchase the target asset. The target score can be preset or predetermined at a selected level or the target score can be calculated or determined by the financial score determination system based on the input data, including the target asset related data (e.g., property information), the creditworthiness data, loan product requirements and associated information, consumer related information, and the like.

The illustrated finance score determination system 10 can include a controller or computing unit 16 for storing and processing, via a processor, the input or source data from the various data sources 12 and for calculating or determining therefrom the finance score. The computing unit 16 can be programmed to process selected types of source or input data and to determine therefrom a finance score related to or associated with the consumer. The illustrated computing unit 16 can include a raw score determination unit 20 for receiving selected types of source data and for determining therefrom a series of raw scores. According to one practice, the source data processed by the raw score determination unit 20 can include, for example, creditworthiness data, such as credit score data, and consumer provided source data, such as personal financial information, banking information, loan related information, as well as target asset related information, such as the type and value of the property to be purchased and any associated loan products.

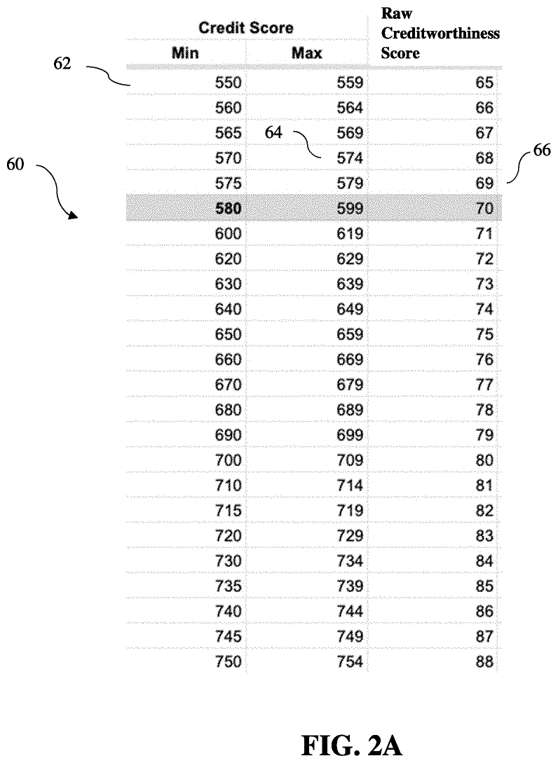

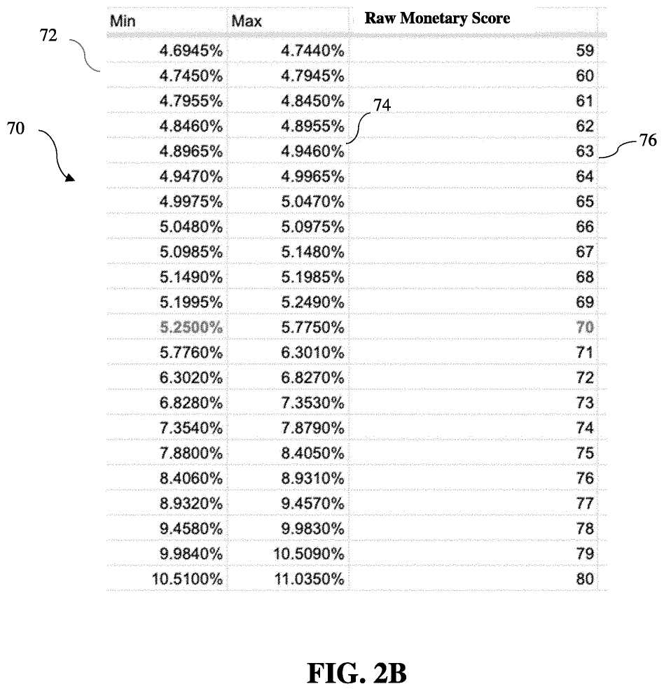

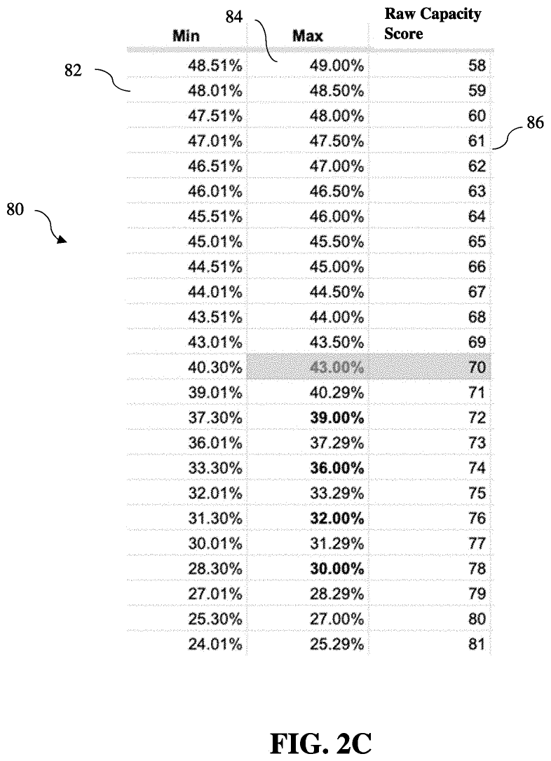

Specifically, the raw score determination unit 20 can generate or create an initial or raw creditworthiness score from the input creditworthiness data 12A. The raw score determination unit 20 generates a raw creditworthiness score value based on selected types of creditworthiness data, including for example credit score data associated with the consumer and which can be received from the creditworthiness data source 12A, and optionally based on the target asset data, such as, for example, loan product and property information received from the target asset data source 12C. The raw score determination unit 20 compares, for example, the credit score data with any threshold credit score value or requirement associated with a loan product, and then determines therefrom the raw creditworthiness score. Alternatively, the finance score determination system 10 can store information based on a number of different loan products, and can provide threshold information based on an average or typical credit score required by the loan products. This information can be stored in any selected format, and can be stored for example as structured table in a table format. The raw creditworthiness score can be expressed in any selected form or format, such as for example as a percentage or as value or number. The raw score determination unit 20 determines if the received credit score information meets the threshold requirement for the loan product. According to one embodiment, if the value of the credit score information of the consumer exceeds the value of the threshold credit score of the loan, then the raw score determination unit 20 can generate a raw creditworthiness score of 100%. If the value of the consumer credit score is less than the value of the threshold credit score associated with the loan, then the raw score determination unit 20 divides the actual consumer credit score by the threshold credit score to determine the raw credit worthiness score. One of ordinary skill in the art will readily recognize that the raw scores, including the raw creditworthiness score and the other scores calculated by the computing unit 16, can be determined in many different ways, with the current embodiment being just one example. According to an alternate embodiment, the raw score determination unit 20 can employ one or more tables listing or having a range of credit scores and which associates or correlates with each credit score in the table a raw creditworthiness score, as shown for example in FIG. 2A.

The raw score determination unit 20 can also generate a raw monetary score from selected consumer related information 12B. For example, the raw score determination unit 20 can process the available or accessible money or cash information of the consumer and the required or threshold cash information associated with the loan product and target property to determine the minimum cash needed to purchase the property. The raw score determination unit 20 thus determines the threshold cash amount, expressed as a monetary amount or as a percentage of the purchase price of the target asset, required to complete the purchase of the property. The required or threshold cash amount can include the costs associated with the loan closing and down payment information associated with the loan and property (e.g., target assets). The raw score determination unit 20 then compares the required cash information with the accessible cash information of the consumer. If the value of the accessible cash information of the consumer exceeds the value of the required cash information, which is a threshold cash amount, then the raw score determination unit 20 can generate, according to one embodiment, a raw monetary score of 100%. If the value of the accessible cash information is less than the value of the required cash information, then the raw score determination unit 20 divides the accessible cash value by the required cash value to determine the raw monetary score. This raw monetary score can be expressed in terms of percentages. Alternatively, the finance score determination system 10 can store information based on a number of different loan products, and can provide threshold information based on an average or typical monetary amounts required by the loan products. This information can be stored in any selected format, and can be stored for example as structured table in a table format. According to an alternate embodiment, the raw score determination unit 20 can employ one or more tables listing or having a range of monetary values and which associates or correlates with each monetary amount in the table a raw monetary score, as shown for example in FIG. 2B.

The raw score determination unit 20 can also be programmed to determine a raw capacity score from the input or source data. For example, the raw score determination unit 20 receives and processes the personal financial information of the consumer received from the data source 12B, such as debt and loan obligation information and income information of the consumer. The raw score determination unit 20 also receives insurance information from the data source 12n. From this combined source data, the raw score determination unit 20 can determine a debt-to-income ratio (e.g., capacity ratio) of the consumer. The debt-to-income (DTI) ratio is typically a percentage of the gross monthly income of the consumer that is required to pay the monthly debt obligations of the consumer. Stated another way, the DTI ratio is the percentage of gross monthly income generated by the consumer that goes toward paying debts, and current and projected debts, of the consumer. This ratio has a value that is indicative or a measure of the ability of the consumer to manage monthly payment obligations. The actual DTI ratio is then compared by the raw score determination unit 20 to a threshold DTI ratio from the loan information (e.g., target asset). According to one embodiment, if the value of the actual DTI ratio is equal to or less than the value of the threshold DTI ratio, then the raw score determination unit 20 generates a raw capacity score of 100%. If value of the actual DTI ratio is greater than the value of the threshold DTI ratio, then the raw score determination unit 20 divides the value of the threshold DTI ratio by the value of the actual DTI ratio to determine the raw capacity score. Alternatively, the finance score determination system 10 can store information based on a number of different loan products, and can provide threshold information based on an average or typical DTI ratio required by the loan products. This information can be stored in any selected format, and can be stored for example as structured table in a table format. Thus, according to an alternate embodiment, the raw score determination unit 20 can employ one or more tables listing or having a range of DTI ratios and which associates or correlates with each ratio in the table a raw capacity score, as shown for example in FIG. 2C.

The raw score information 22 is then conveyed by the raw score determination unit 20 to a weighting unit 24. The weighting unit 24 processes the raw score data and applies one or more weighted values to each of the input raw scores according to a predetermined weight application schedule. For example, according to one embodiment, the weights assigned or applied to the raw monetary score can be greater than the weights assigned or applied to the raw creditworthiness score and to the raw capacity score. The weights assigned or applied to the raw capacity score and to the raw creditworthiness score can be the same or they can be different relative to each other. The weights can have any selected value associated therewith and can be based on any selected scale. For example, according to one embodiment, the weights can be assigned based on a scale of 100. To that end, the weight values assigned to the raw monetary score can be in the range of about 50-60 points, and the weight values assigned to each of the raw capacity score and to the raw creditworthiness score can be between about 20-25 points. As such, according to the current embodiment, the raw monetary score can be weighted so as to comprise between about 50%-60% of the finance score, and the raw creditworthiness score and the raw capacity score can each comprise between about 20%-25% of the finance score. If the weight scale employed by the weighting unit 24 is different, then one of ordinary skill in the art will readily recognize that the foregoing weight value ranges can be mathematically modified based on the parameters of the new scale while concomitantly maintaining the relative weight values. By simple way of illustration, if the weight scale is based on 70 points rather than 100 points, then each of the weight ranges can be reduced by 30%. The weighting unit 24 can apply a preselected creditworthiness weighted value to the raw creditworthiness score to calculate or determine a weighted or final creditworthiness score. Similarly, the weighting unit 24 can apply a preselected monetary weighted value to the raw monetary score to determine a weighted or final monetary score. The weighting unit 24 can also apply a preselected capacity weighted value to the raw capacity score to determine a weighted or final capacity score.

The weighted score data 26 generated by the weighting unit 24 can be conveyed to a finance score determination unit 28. The finance score determination unit 28 can generate the finance score by applying any selected type of arithmetic or mathematical operation to the weighted score data 26 received from the weighting unit 24. According to one embodiment, the finance score determination unit 28 adds or sums the values associated with the weighted scores to determine the overall finance score. For example, the weighted scores, since they are in the illustrative example based on scale of 100, can be combined to form a finance score that is less than or equal to 100. The finance score determination unit can also compare the finance scale to the selected target score to determine if the finance score is less than, equal to, or greater than the target score. If the finance score is less than the target score, then the consumer currently does not meet the minimum or threshold requirements of the loan product. If the finance score is equal to or greater than the threshold requirements, then the consumer meets the requirements of the loan product.

According to another embodiment, the finance score determination system 10 can set a threshold level for each of the raw or weighted scores. If one or more of the raw or weighted scores does not meet the threshold requirement for that particular score, then the finance score determined by the finance score determination unit 28 is automatically set to be less than the target score. This alternate methodology reflects the requirements of selected loan products that require that all three of the raw or weighted scores individually meet specific related thresholds, rather than a composite score that meets a composite target score or threshold.

The computing unit 16 can also include a storage unit 34 for storing any of the data received from the data sources 12, as well as store any of the intermediate or final scores, calculations or determinations of the raw score determination unit 20, the weighting unit 24, and the finance score determination unit 28. For the sake of simplicity, the storage unit 34 is illustrated as forming part of the computing unit 16, although one of ordinary skill in the art will readily understand that the storage unit can form part of any of the units of the system 10 of the present invention. Further, the storage unit can also be implemented as part of a cloud hosting facility.

The finance score 30 generated by the finance score determination unit 28 can be conveyed to a user interface unit 38 for generating a selected user interface for displaying the finance score. Specifically, the user interface unit can generate one or more interfaces that are configured to display the finance score and any additional information, such as the target score, to the consumer. As used herein, the term “user interface” (also referred to as an interactive user interface, a graphical user interface or a UI), may refer to a computer-provided interface including data fields or other controls for receiving input signals or providing electronic information or for providing information to a user in response to received input signals. A user interface may be implemented, in whole or in part, using technologies such as hyper-text mark-up language (HTML), a programming language, web services, or rich site summary (RSS). In some implementations, a user interface may be included in a stand-alone client software application configured to communicate in accordance with one or more of the aspects described.

The computing unit 16 or the user interface unit 38 can also employ an optional recommendation unit 40 for providing recommendations and tips to the user. For example, if the user is the consumer, then the recommendation unit 40 can provide tips, hints, and recommendations to the consumer about how to increase the finance score, especially if the finance score is below the target score. The tips and hints can include specific monetary actions that the consumer can take to increase the score, as well as to provide recommended financial goals that can assist the consumer in reaching the target score. The recommendation unit 40 can also provide selected financial reports on a predetermined or user selectable frequency basis, as well as provide alerts and other types of notifications associated with any of the information provided to the system. The recommendation unit 40 can also be configured to employ one or more machine learning or artificial intelligence techniques that can be properly trained on selected training data, which can include selected sets and types of creditworthiness data, typical consumer data, and target asset data, so as to provide recommendations, predictive analytics and hints to the user regarding reaching a target goal, as well as other financial goals that are important to the user.

As shown in FIG. 1, the illustrated computing unit 16 can also include an optional confidence scoring unit 44 for applying a confidence value to the weighted score data 26 generated by the weighting unit 24. The confidence value can be any preselected value that is associated with one or more selected types of source data and is indicative of the reliability or trustworthiness of the source data. For example, the source data provided or inputted directly by the consumer can be deemed to have a lower reliability, and hence be assigned a lower reliability score, because of the possibility that the data entered by the consumer is accidentally or purposefully inaccurate. Likewise, source data that is provided by one of the other data sources and which is deemed to be of higher accuracy and reliability, such as information from credit bureaus, can be assigned a higher confidence score or value. The confidence scores can be arithmetically applied to the weighted score data 26 prior to introduction to the finance score determination unit 28.

The finance score determination system 10 of the present invention can also allow consumers to view and track their current home value or to track the home value of a target house based on the input data 12. The system 10 can also provide information associated with a refinancing loan product, such that the system, based on the input data, including the home value, can recommend or model refinancing terms and any associated impact on the financials of the consumer.

The system of the present invention can also be configured to allow the consumer to set multiple different financial goals and to provide information that allows the consumer to see the impact on, for example, the finance score. The recommendation unit 40 can also generate recommendations associated with selected debts to retire, recommended order for paying debts, how much to save to meet the goals, and the like. The finance score 30 can also provide meaningful information to a consumer who is looking to rent rather than purchase property.

In operation, the finance score determination system 10 of the present invention employs, for the sake of simplicity, a controller or computing unit 16 for receiving and processing many different types of source or input data received from the data sources 12. The source data can include creditworthiness data (from data source 12A), consumer related data (from data source 12B), target asset data (from data source 12C), and additional data from one or more third party sources (from data sources 12n). The creditworthiness data can include credit score information, the consumer related data can include income, cash and debt information, the target related data can include property and loan product information, and the third party data can include tax and insurance information. The third party data can also include additional types of data, including for example additional financial related information, including frequency of payment of salary, consistency of salary payments, driving related information including driving record and the like, work location data, and distance from primary address to work. Based on the source data, the finance score determination system 10 of the present invention can generate the finance score so as to assist the consumer in better understanding their current financial position as it pertains to qualifying for financing or for a loan for purchase of a target asset, such as property. Specifically, the finance score conveys to the consumer, in a simple and easy to read manner, whether the consumer is on pace or goal to be able to purchase the selected item (e.g., target asset). The computing unit 16 is also capable of receiving on-demand updates to the source data to provide for a dynamically changing finance score in real-time. Further, the system 10 can be configured such that the target score can be reached only when selected threshold scores associated with each portion of the finance score are reached. As such, excess points associated with one specific portion of the finance score 30 (e.g., creditworthiness score) are not considered when initially determining if the target score is reached.

The finance score determination system 10 initially allows the user to identify the asset or item to be purchased, for example, a house, into the computing unit 16 via known techniques. Alternatively, if the consumer is interested in purchasing a house, they can enter identification information related to the house or region, such as a zip code, town/city name, county information, street address, and the like, into the system. Further, the finance score determination system 10 can retrieve from the various data sources 12 information related to the item, such as for example median house price information in a specific area (e.g., zip code or town), tax related information, insurance related information, valuation information, appraisal information, and the like. The source or input data is then processed by the computing unit to generate a finance score. The finance score determination system 10 also analyses information related to selected financial factors, including consumer money position, consumer debt and income information (e.g., consumer debt-to-income ratio), and the consumer creditworthiness information. Information related to these factors can come from the consumer as well as from third party data sources. The system of the present invention can display any selected indicia associated with the factors in a selected user interface generated by the user interface unit 38, and can generate a consumer specific finance score that conveys to the user the relative possibility of purchasing the specific item. The finance score 30 as well as the other related factors, are dynamic and are updated in real time based on updated information provided from the consumer and from the third party data sources. The system 10 of the present invention can also provide tips and guidance and related information that conveys to the consumer the actions that need to be taken if the consumer wishes to reach a selected target score that indicates the users ability to purchase the identified item.

According to another embodiment, the finance score determination system 10 can, based on selected portions of the input data, generate and display a time-to-target estimation, where the system 10 determines or predicts the amount of time it may take the consumer to reach the target score based on all three portions of the finance score 30. The system 10 can employ artificial intelligence or other types of machine learning techniques to determine the appropriate timeline.

The finance score 30 calculated by the finance score determination unit 28 can be calculated or determined as follows. The finance score 30 can be based on multiple different categories or types of data. The first data category is specific to the consumer and the second data category is specific to the target asset, and includes a specific property or location and a loan product. In relation to the consumer data, the computing unit 16 can receive either consumer supplied or third party supplied data. Alternatively, the system can have consumer supplied data and third party verified data. A suitable example of verified third party data can be monthly payroll information. The consumer-centric data can be processed by the computing unit 16 to determine one or more raw scores, weighted, and which are then used to determine the finance score. The finance score can be compared on a relative scale to a target score or can be simultaneously displayed with the target score. The consumer data and the loan product data can be processed by the raw score determination unit 20 to determine a raw monetary score and a raw capacity score. The raw score determination unit 20 can also process creditworthiness data, such as credit score information, to determine a raw creditworthiness score. The raw scores from the raw score determination unit 20 can then be conveyed to and processed by the weighting unit 24 that selectively applies weighted values to each of the raw scores. The weighted values applied to the raw scores can be the same or can differ relative to each other. The raw scores can optionally be further processed by a confidence scoring unit 44 that can apply to each of the weighted scores generated by the weighting unit 24 a confidence level value that is indicative of the system's confidence in the received data. The score data are is then processed by the finance score determination unit 28 for determining the finance score directly from the weighted scores or optionally from the weighted scores that have confidence level scores applied thereto. The system can display the finance score and the target score to the consumer or user via one or more user interfaces.

Initially, the system is unable to determine how much money the consumer needs to save to purchase an item until the item is identified. The system can compare the input data to not only the target, but any associated industry minimums and maximums, which provides the system with the ability to determine a likely path to qualification for the consumer.

The following are illustrative examples of the processing of data by the finance score determination system 10 and is intended to be merely illustrative of the present invention.

### Example 1

According to one example, the finance score determination system 10 of the present invention can determine a finance score for a selected consumer from a variety of input data types. The following figures and values are for the express purpose of illustrating the various calculations and processing performed by the current system and associated units and should not be construed in a limiting sense. In order to determine the finance score, the financial score determination system 10 of the present invention initially receives or retrieves selected types of data. The input data can include, for example, target asset related data such as loan product information and property related information, consumer related data, creditworthiness data, and other third party data including tax and insurance related information. According to the current example, the target asset and other related data includes:
Target|Location (zip code): 42718
Target|Loan Type: FHA
Est. Mortgage Monthly Principal and Interest: $808.52
Est. Monthly Mortgage Insurance: $129
Selected Loan Term: 30 years
Est. Rate: 2.93%
Down Payment: 3.5%
Est. Loan-specific closing costs: $3,625
Est. Down Payment required: $7,525 (3.5%× Home Price)
Maximum Capacity Threshold (DTI %): 43%
Minimum Credit Score Threshold on Loan: 580

The consumer related information provided by the consumer or by third party data sources includes:
Accessible Cash: $5,776
Monthly Gross Income: $3,965
Current Monthly Required Debt Service Payments: $459
Military/Veteran Status: No

The creditworthiness data provided by the data source 12A can include:
Credit Score: 575

The financial score determination system 10 can then receive or retrieve selected data from one or more third party data sources 12C and 12n based on the consumer's initial input data. The third party data can include:
Home Price (actual with address or median with non-address): $215,000
Est Homeowners Insurance: $137.24
Est. Flood Insurance (if applicable): N/A
Est. Property Taxes: $130.79

The system can then determine or calculate, from the foregoing data, an initial or raw score for each of money, creditworthiness and capacity by using both consumer-supplied and publicly available third party data sources. The finance score can also be considered as a real time percentage achieved relative to a target percentage (e.g., target score). From the foregoing input data, the raw score determination unit 20 determines a raw monetary score having an associated value. For example, the raw score determination unit 20 considers the following cash related information:
Accessible Cash: $5,776
Est. Loan-Specific Closing Costs ($3,625)
Est. Down Payment Required ($7,525)
Calculate Total Est. Cash Required ($3,625+$7,525)=$11,150.

The raw score determination unit 20 can then determine the raw monetary score by dividing $5,776 (Accessible Cash) by $11,150 (cash required)=51.8%

The raw score determination unit 20 can also determine the raw creditworthiness score by comparing the actual credit score of the consumer with the minimum or threshold credit score as provided by the loan requirements. For example, the raw creditworthiness score can be calculated as follows:
Consumer credit score: 575
Minimum Credit Score: 580
Raw creditworthiness score determined by dividing the consumer credit score (575) by the minimum required credit score (580)=99.1%

The raw score determination unit 20 can also determine the raw capacity score by comparing the consumer financial information with the minimum or threshold financial information forming part of the loan requirements. The pertinent information is as follows:
Current Monthly Required Debt Service Payments ($459)
Gross Income ($3965)
Est. Homeowners Insurance ($137.24)
Est Monthly Mortgage Insurance ($129)
Est Mortgage Monthly Principal and Interest ($808.52)
Est. Flood Insurance (N/A)

The raw capacity score can be calculated by adding together the current monthly required debt service payments, the estimated Homeowners Insurance, the estimated Monthly Mortgage Insurance, the estimated Mortgage Monthly Principal and Interest, the estimated Flood Insurance (if applicable), and the estimated Property Taxes. In this example, these debt components add up to $1,664.55 per month. This amount is then divided by the monthly gross income of $3975, which results in a DTI ratio or capacity of 41.8%. Since the 41.8% capacity is less than the threshold capacity of the loan (43%), then the raw capacity score is determined to be 100%. If the calculated capacity is greater than the maximum capacity threshold, then the raw capacity score is determined by dividing the threshold DTI ratio by the actual DTI ratio.

The raw scores are then conveyed to the weighting unit 24. The weighting unit 24 then applies a weighted value to each of the raw scores. In the current example, the weighted values are predefined or prestored as follows:
raw money score weighted value is 60%
raw creditworthiness score weighted value is 20%
raw capacity score weighted value is 20%

As such, the weighting unit 24 applies the weighted values to each of the raw scores and generates weighted score values. In the current example, the weighted creditworthiness score is determined by the weighting unit 24 by applying any selected type of arithmetic operation, such as by multiplying the raw creditworthiness score (99.1%) by the assigned weighted value (20% or 0.20) to generate a weighted creditworthiness score of 19.82. Similarly, the final monetary score can be calculated by multiplying the raw monetary score (51.8%) by the weighted value (60% or 0.60) to generate a weighted monetary score of 31.08. The weighting unit 24 then determines the final capacity score by multiplying the raw capacity score (100%) by the assigned weighted value (20% or 0.20) to generate a final capacity score of 20.

The weighted scores are then conveyed to the finance score determination unit 28 by applying to the final scores a selected arithmetic operation. According to one embodiment, the finance score determination unit 28 adds or sums together the final scores to arrive at the finance score. In the current example, the final scores are summed (19.82+31.08+20) to arrive at the finance score of 70.9. The finance score can then be conveyed by the computing unit 16 to the user interface unit 38 that can generate a suitable interface for displaying the finance score.

The computing unit 16 can also determine or have prestored a target score that serves as a goal or target for the consumer to attain. Once the indicated target score is attained, the consumer qualifies to purchase the selected target asset, since all financial threshold obligations are met. The finance score can then be compared with or displayed alongside of the target score. In this example, the target score can be 70%. As such, the consumer qualifies for the indicated loan.

The finance score determination system 10 allows the consumer to monitor, on an on-going basis, their personal finance score. The finance score can be calculated by the computing unit 16 by measuring the measured change of money (e.g., cash), creditworthiness and capacity, relative to the target score. Additionally, the relative change in the finance score of the consumer can be influenced by any measurable changes in the target asset, such as increasing or decreasing home values, different property locations, changing interest rates, and the like.

The computing unit 16 of the finance score determination system 10 of the present invention can be configured to monitor the source data and recalculate the various components of the finance score so as to adjust, change or vary the finance score in real time based on real time changes in the underlying data.

The below additional example is a sample calculation illustrating the real time monitoring and adjustment of the calculated finance score. This example is intended to be illustrative and should not be construed in a limiting sense.

### Example 2

The computing unit 16 can be programmed or configured to monitor and measure any relative changes to the finance score of the consumer. The following numbers and amounts are simply for illustrative purposes. This example is different than Example 1.

The property identified by the consumer or recommended by the system is monitored by the computing unit so as to determine any changes, if they exist, in the value of the property. Further, the terms of the loan provided by the consumer of the system are also monitored for any changes. For example, the financial score determination system 10 monitors the loan product for changes in the associated interest rate information, closing cost information, down payment information, and the like. The property and loan information may or may not result in a recurring impact on the calculated finance score, except in the limited case where the system is monitoring the estimated purchase price of the property. The computing unit can calculate the change in finance score and target score based on changes in the source data.

For example, with regard to cash available to cover any associated closing costs, let's assume that the consumer has $25 saved for purchase of the property and the calculated closing total closing costs equal $10,000. The consumer thus needs to save $9,975 in order to cover the total closing costs of the property. In the cash category, the system determines that a total of 60 points are available to dedicate to this category, which corresponds to the weighted value of this category. The system 10 then divides the amount of cash needed by the consumer to meeting the closing cost requirements by the points available in the category ($9,975/60) to correlate money saved with points. As such, in the current example, for every $166.25 saved by the consumer, the final monetary score portion of the finance score increases by 1 point.

Further, the computing unit 16 can further determine the appropriate increase in the final creditworthiness score by subtracting the consumer credit score from the threshold credit score requirement associated with the loan and then dividing the difference amount by 20. Pursuant to the current example, the loan required credit score is 580 and the consumer has a credit score of 520. The difference between the two scores is divided by the weighted value of the category (60/20) for a value of 3. As such, in the current example, for every 3 point increase in credit score the final creditworthiness score, and hence the financial score, increases by 1 point.

Similarly, for the final capacity score, which corresponds to the consumer DTI ratio information, the system compares the actual DTI ratio of the consumer with the required DTI ratio of the loan. When the consumer DTI ratio is higher than the required DTI ration, then the system subtracts the required DTI ratio value from the actual DTI ratio value, and then divides the difference by the weighted value for the category. In the current example, the consumer DTI ratio is 55% and the required DTI ratio is 50%. As such, the difference is divided by the weighted value (5/20) to arrive at 0.4%. As such, for each reduction of the actual DTI ratio of 0.4% corresponds to a 1 point increase in the capacity score, and hence of the finance score.

The resultant formulas programmed into the computing unit 16 include the determination of the finance score as follows:

Final capacity score (relative to target location and target loan)+final monetary score (e.g., cash-to-close)(relative to target location and target loan)+final creditworthiness score (relative to target loan)=Finance score (relative to target and financial goal)

The computing unit 16 can be programmed to monitor the various data, measure the various changes in the data, and then rescore the various categories, including capacity, monetary position (e.g., cash-to-close), creditworthiness, and target asset.

### Example 3

According to another example, the finance score determination system 10 of the present invention can determine a finance score for a selected consumer from a variety of input data types, and rather than performing a mathematical calculation to determine the raw and weighted scores, the system can employ prestored structured data, such as tables or matrices, that correlate selected scores or ranges of scores to selected creditworthiness, monetary, and capacity type data. The following figures and values are for the express purpose of illustrating the various determinations and processing that is performed by the system and associated units and should not be construed in a limiting sense.

In order to determine the finance score, the financial score determination system 10 of the present invention initially receives or retrieves selected types of data. The input data can include, for example, target asset related data such as loan product information and property related information, consumer related data, creditworthiness data, and other third party data including tax and insurance related information.

The computing unit 16 can be programmed or configured to measure relative changes to the finance score of the consumer by searching for the values correlated to selected data received from the data sources 12 within lookup tables or matrixes.

The system can determine or calculate, from the underlying data 12, raw scores for each of money, creditworthiness and capacity by accessing and retrieving score data from tables. In this example, there exists a separate table for each of money, creditworthiness, and capacity. In this example the raw score determination system illustrates the system's ability to establish qualification thresholds at any raw score value.

In this example, the financial score determination system 10 has implemented “70” as the raw score threshold for all three types of raw scores, such as the creditworthiness, capacity, and monetary raw scores, as well as for the finance score.

The consumer input data includes a consumer credit score of 750, a capacity or DTI ratio score of 45%, and a monetary (cash-to-close) score of 10%. The monetary score can also be determined as a monetary amount rather than a percentage of the purchase price for the house. The property to be acquired is valued at $100K and the loan product requirements include threshold values of 43% for capacity, 5.25% for cash, and a credit score of 580.

The raw score determination unit 20 can access the information stored in the respective tables illustrated in FIGS. 2A-2C. For example, as shown in FIG. 2A, the table 60 sets forth credit scores or ranges of credit scores, as shown in columns 62 and 64. The credit scores are correlated to specific raw creditworthiness scores, as shown in column 66. FIG. 2A only displays a portion of the table 60, since the table has credit score ranges associated with raw creditworthiness scores ranging from 0 to 100. In the current example, the credit score of 750 is correlated with a raw creditworthiness score of 88.

The raw score determination unit 20 also can access the information stored in the table 70 illustrated in FIG. 2B. The illustrated table 70 sets forth ranges of cash amounts (cash-to-close), as shown in columns 72 and 74. The cash amounts are correlated to specific raw monetary scores, as shown in column 76. FIG. 2B also displays a portion of the table 70, since the table has monetary amount ranges associated with raw monetary scores ranging from 0 to 100. In the current example, the monetary value of the consumer is 10%, and is correlated with a raw monetary score of 79. The foregoing cash percentage is a percentage of the purchase price of the house, but could also be formatted using other format values, such as monetary or cash amounts.

The raw score determination unit 20 can also access the information stored in the table 80 of FIG. 2C. The illustrated table 80 sets forth capacity (DTI ratio) values or ranges of capacity values, as shown in columns 82 and 84. The capacity values are correlated to specific raw capacity scores, as shown in column 86. FIG. 2C only displays a portion of the table 80 since the table has capacity value ranges associated with raw capacity scores ranging from 0 to 100. In the current example, the capacity value of 45% is correlated with a raw capacity score of 66.

The raw scores 22 are then conveyed to the weighting unit 24, which applies weighted values to the raw scores. In the current example, the monetary weight is 60%, the capacity weight is 20%, and the creditworthiness weight is 20%. The weighting unit thus creates a weighted monetary score of 47.4, a weighted capacity score 13.2, and a weighted creditworthiness score of 17.6. The weighted scores 26 are then conveyed to the finance score determination unit 28. The finance score determination unit 28 can sum the score values to arrive at a finance score of 78.2, which would exceed the threshold or target score of 70. However, the capacity value of 45% is above the threshold value of 43%, which corresponds in table 80 to the threshold 70. In this circumstance, the finance score determination unit 28 recalculates the finance score such that the raw scores that exceed the threshold are constrained to raw scores associated with the threshold or target value of 70, and the excess or surplus raw score points are temporarily ignored. The recalculated raw scores then include a raw creditworthiness score of 70 instead of 88, for a new weighted creditworthiness score of 14, and a raw monetary score of 70 instead of 79, for a new weighted monetary score of 42. The weighted capacity score of 13.2 remains unchanged. The new recalculated finance score is then 69.2, which is below the threshold or target score of 70.

If, based on updated input data, it is determined that the consumer's DTI or capacity score is now at 43%, which meets the threshold value set at 70, then the scores are recalculated by the finance score determination system 10. For example, the raw capacity score changes to 70 from 66. The weighted capacity score changes to 14. Since now all three scores meet or exceed values associated with the threshold score of 70, the finance score determination unit 28 calculates the full finance score. In the current updated example, the full, non-constrained weighted monetary score of 47.4 and weighted creditworthiness score of 17.6 is added to the weighted capacity score of 14 to determine an updated finance score of 79. The finance score of 79 exceeds the target score of 70, which indicates that the consumer qualifies for a loan or for a specific loan product.

### Exemplary Hardware and Software

As used herein, the terms “determine” or “determining” may include a variety of actions. For example, “determining” may include calculating, computing, processing, deriving, looking up (e.g., looking up in a table, a database or another data structure), ascertaining, or other actions. Also, “determining” may include receiving (e.g., receiving information or data), accessing (e.g., accessing data in a memory, data storage, distributed ledger, or over a network), or other actions. Also, “determining” may include resolving, selecting, choosing, establishing, or other similar actions.

As used herein, the terms “provide” or “providing” may include a variety of actions. For example, “providing” may include generating data, storing data in a location for later retrieval, transmitting data directly to a recipient, transmitting or storing a reference to data, or other actions. “Providing” may also include encoding, decoding, encrypting, decrypting, validating, verifying, or other actions

It is to be understood that although the invention has been described above in terms of particular embodiments, the foregoing embodiments are provided as illustrative only, and do not limit or define the scope of the invention. Various other embodiments, including but not limited to those described herein are also within the scope of the claims. For example, elements, units, modules, tools and components described herein may be further divided into additional components or joined together to form fewer components for performing the same functions. Any of the functions, components and units disclosed herein may be implemented by an electronic or computing device as described herein.

The techniques, processes and methods described above may be implemented, for example, in hardware, one or more computer software programs tangibly stored on one or more computer-readable media, firmware, or any combination thereof. The techniques described above may be implemented by one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input data or information entered using the input device to perform the functions described herein and to generate output using the output device.

The term computing device or electronic device can refer to any device that includes a processor and a computer-readable memory capable of storing computer-readable instructions, and in which the processor is capable of executing the computer-readable instructions in the memory. The terms computer system and computing system refer herein to a system containing one or more computing devices.

Embodiments of the present invention include features which are only possible and/or feasible to implement with the use of one or more computers, servers, clients, computer processors, and/or other elements of a computer system. Such features are either impossible or impractical to implement mentally and/or manually. For example, embodiments of the present invention may operate on digital electronic processes which can only be created, stored, modified, processed, and transmitted by computing devices and other electronic devices. Further, the raw scores, weighted scores, and finance score of the present invention is impractical to determine mentally for each user of the system because of the vast amount of input data, the dynamic nature of the input data, and the like. Such embodiments, therefore, address problems which are inherently computer-related and solve such problems using computer technology in ways which could not be solved manually or mentally by humans.

Any claims herein which affirmatively require a computer, a processor, a memory, storage, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to encompass methods which are performed by any recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Embodiments of the present invention solve one or more problems that are inherently rooted in computer technology. There is no analog to this problem in the non-computer environment, nor is there an analog to the solutions disclosed herein in the non-computer environment.

Furthermore, embodiments of the present invention represent improvements to computer and communication technology itself. For example, the financial score determination system 10 of the present invention can optionally employ a specially programmed or special purpose computer in an improved computer system, which may, for example, be implemented within a single computing device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

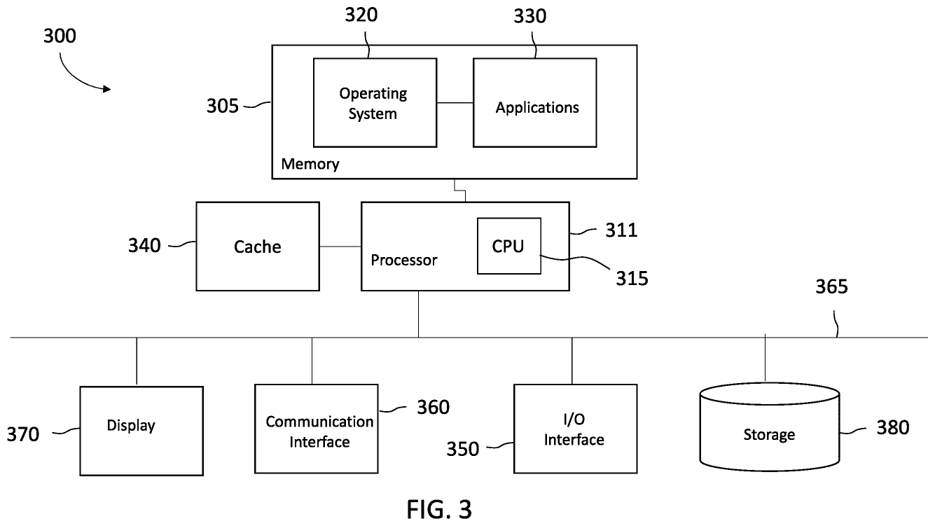

It should also be appreciated that various concepts described herein may be implemented in any number of ways, as the disclosed concepts are not limited to any particular manner of implementation or system configuration. Examples of specific implementations and applications are provided below primarily for illustrative purposes and for providing or describing the operating environment of the system of the present invention. The financial score determination system 10 of the present invention can employ a plurality of units or modules that can be implemented by one or more electronic devices or portions thereof, such as one or more servers, clients, client devices, computers and the like, that are networked together or which are arranged so as to effectively communicate with each other. The network can be any type or form of network. The devices can be on the same network or on different networks. In some embodiments, the network system may include multiple, logically-grouped servers. In one of these embodiments, the logical group of servers may be referred to as a server farm or a machine farm. In another of these embodiments, the servers may be geographically dispersed or are hosted in known cloud computing platforms. The electronic devices can communicate through wired connections or through wireless connections. The clients can also be generally referred to as local machines, clients, client nodes, client machines, client computers, client devices, endpoints, or endpoint nodes. The servers can also be referred to herein as servers, nodes, or remote machines. In some embodiments, a client has the capacity to function as both a client or client node seeking access to resources provided by a server or node and as a server providing access to hosted resources for other clients. The clients can be any suitable electronic or computing device, including for example, a computer, a server, a smartphone, a smart electronic pad, a portable computer, and the like, such as the electronic device 300 illustrated in FIG. 3. Further, the server may be a file server, application server, web server, proxy server, appliance, network appliance, gateway, gateway server, virtualization server, deployment server, SSL VPN server, or firewall, or any other suitable electronic or computing device, such as the electronic device 300. In one embodiment, the server may be referred to as a remote machine or a node. In another embodiment, a plurality of nodes may be in the path between any two communicating servers or clients. The financial score determination system 10 of the present invention can be stored on one or more of the clients, servers, and the hardware associated with the client or server, such as the processor or CPU and memory described below. The servers and associated hardware can be in a single location, distributed over multiple locations, or can be hosted on known cloud computing platforms.

FIG. 3 is a high-level block diagram of an electronic device 300 that can be used with the embodiments disclosed herein. Without limitation, the hardware, software, and techniques described herein can be implemented in digital electronic circuitry or in computer hardware that executes firmware, software, or combinations thereof. The implementation can be as a computer program product (e.g., a non-transitory computer program tangibly embodied in a machine-readable storage device, for execution by, or to control the operation of, one or more data processing apparatuses, such as a programmable processor, one or more computers, one or more servers and the like).

The illustrated electronic device 300 can be any suitable electronic circuitry that includes a main memory unit 305 that is connected to a processor 311 having a CPU 315 and a cache unit 340 configured to store copies of the data from the most frequently used main memory 305.

Further, the methods and procedures for carrying out the methods disclosed herein can be performed by one or more programmable processors executing a computer program to perform functions of the invention by operating on input data and generating output. Further, the methods and procedures disclosed herein can also be performed by, and the apparatus disclosed herein can be implemented as, special purpose logic circuitry, such as a FPGA (field programmable gate array) or an ASIC (application specific integrated circuit). Modules and units disclosed herein can also refer to portions of the computer program and/or the processor/special circuitry that implements that functionality.

The processor 311 is any logic circuitry that responds to, processes or manipulates instructions received from the main memory unit, and can be any suitable processor for execution of a computer program. For example, the processor 311 can be a general and/or special purpose microprocessor and/or a processor of a digital computer. The CPU 315 can be any suitable processing unit known in the art. For example, the CPU 315 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. Alternatively or additionally, the processor can comprise at least one of a multi-core processor and a front-end processor. Generally, the processor 311 can be embodied in any suitable manner. For example, the processor 311 can be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. Additionally or alternatively, the processor 311 can be configured to execute instructions stored in the memory 305 or otherwise accessible to the processor 311. As such, whether configured by hardware or software methods, or by a combination thereof, the processor 311 can represent an entity (e.g., physically embodied in circuitry) capable of performing operations according to embodiments disclosed herein while configured accordingly. Thus, for example, when the processor 311 is embodied as an ASIC, FPGA or the like, the processor 311 can be specifically configured hardware for conducting the operations described herein. Alternatively, as another example, when the processor 311 is embodied as an executor of software instructions, the instructions can specifically configure the processor 311 to perform the operations described herein. In many embodiments, the central processing unit 530 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The processor can be configured to receive and execute instructions received from the main memory 305.

The electronic device 300 applicable to the hardware of the present invention can be based on any of these processors, or any other processor capable of operating as described herein. The central processing unit 315 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5, i7, and i9.

The processor 311 and the CPU 315 can be configured to receive instructions and data from the main memory 305 (e.g., a read-only memory or a random access memory or both) and execute the instructions. The instructions and other data can be stored in the main memory 305. The processor 311 and the main memory 305 can be included in or supplemented by special purpose logic circuitry. The main memory unit 305 can include one or more memory chips capable of storing data and allowing any storage location to be directly accessed by the processor 311. The main memory unit 305 may be volatile and faster than other memory in the electronic device, or can dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 305 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 305 can be based on any of the above described memory chips, or any other available memory chips capable of operating as described herein. In the embodiment shown in FIG. 3, the processor 311 communicates with main memory 305 via a system bus 365. The computer executable instructions of the present invention may be provided using any computer-readable media that is accessible by the computing or electronic device 300. Computer-readable media may include, for example, the computer memory or storage unit 305. The computer storage media may also include, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. n contrast, communication media may embody computer readable instructions, data structures, program modules, or other data in a modulated data signal, such as a carrier wave, or other transport mechanism. As defined herein, computer readable storage media does not include communication media. Therefore, a computer storage or memory medium should not be interpreted to be a propagating signal per se or stated another transitory in nature. The propagated signals may be present in a computer storage media, but propagated signals per se are not examples of computer storage media, which is intended to be non-transitory. Although the computer memory or storage unit 305 is shown within the computing device 300 it will be appreciated that the storage may be distributed or located remotely and accessed via a network or other communication link.

The main memory 305 can comprise an operating system 320 that is configured to implement various operating system functions. For example, the operating system 320 can be responsible for controlling access to various devices, memory management, and/or implementing various functions of the asset management system disclosed herein. Generally, the operating system 320 can be any suitable system software that can manage computer hardware and software resources and provide common services for computer programs.

The main memory 305 can also hold application software 330. For example, the main memory 305 and application software 330 can include various computer executable instructions, application software, and data structures, such as computer executable instructions and data structures that implement various aspects of the embodiments described herein. For example, the main memory 305 and application software 330 can include computer executable instructions, application software, and data structures, such as computer executable instructions and data structures that implement various aspects of the content characterization systems disclosed herein, such as processing and capture of information. Generally, the functions performed by the content characterization systems disclosed herein can be implemented in digital electronic circuitry or in computer hardware that executes software, firmware, or combinations thereof. The implementation can be as a computer program product (e.g., a computer program tangibly embodied in a non-transitory machine-readable storage device) for execution by or to control the operation of a data processing apparatus (e.g., a computer, a programmable processor, or multiple computers). Generally, the program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet.

The processor 311 can further be coupled to a database or data storage 380. The data storage 380 can be configured to store information and data relating to various functions and operations of the content characterization systems disclosed herein. For example, as detailed above, the data storage 380 can store information including but not limited to captured information, multimedia, processed information, and characterized content.

A wide variety of I/O devices may be present in or connected to the electronic device 300. For example, the device can include a display 370. The display 370 can be configured to display information and instructions received from the processor 311. Further, the display 370 can generally be any suitable display available in the art, for example a Liquid Crystal Display (LCD), a light emitting diode (LED) display, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays, or electronic papers (e-ink) displays. Furthermore, the display 370 can be a smart and/or touch sensitive display that can receive instructions from a user and forwarded the received information to the processor 311. The input devices can also include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output devices can also include video displays, graphical displays, speakers, headphones, inkjet printers, laser printers, and 3D printers.

The electronic device 300 can also include an Input/Output (I/O) interface 350 that is configured to connect the processor 311 to various interfaces via an input/output (I/O) device interface 380. The device 300 can also include a communications interface 360 that is responsible for providing the circuitry 300 with a connection to a communications network (e.g., communications network 120). Transmission and reception of data and instructions can occur over the communications network.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and desired to be secured by Letters Patent is:

We claim:

1. A finance score determination system for determining a finance score of a consumer, comprising
a raw score determination unit for receiving at least creditworthiness data, consumer related data, and target asset related data to form received data, and processing the received data to determine a raw creditworthiness score, a raw monetary score, and a raw capacity score,
a weighting unit for applying a selected weighted value to the raw creditworthiness score to form a weighted creditworthiness score, to the raw monetary score to form a weighted monetary score, and to the raw capacity score to form a weighted capacity score, and
a finance score determination unit for determining the finance score by arithmetically combining the weighted creditworthiness score, the weighted capacity score and the weighted capacity score.

2. The system of claim 1, wherein the creditworthiness data includes credit score information and wherein the raw score determination unit determines the raw creditworthiness score by comparing the credit score information with a threshold credit score of a loan product.

3. The system of claim 2, wherein the consumer related data includes monetary information, and wherein the raw score determination unit determines the raw monetary score by comparing the monetary information with a threshold monetary value of the loan product.

4. The system of claim 3, wherein the consumer related data includes income and debt information associated with the consumer, and wherein the raw score determination unit determines the raw capacity score by determining a debt-to-income (DTI) ratio of the consumer and comparing the DTI ratio with a threshold DTI ratio of the loan product.

5. The system of claim 4, wherein the selected weighted value associated with the raw monetary score is greater than the selected weighted value associated with the raw creditworthiness score and the selected weighted value associated with the raw capacity score.

6. The system of claim 5, wherein the selected weighted value associated with the raw creditworthiness score is about equal to the selected weighted value associated with the raw capacity score.

7. The system of claim 5, wherein the selected weighted value associated with the raw monetary score is about three times greater than the selected weighted value associated with the raw creditworthiness score and the weighted value associated with the raw capacity score.

8. The system of claim 5, further comprising a user interface unit for generating one or more user interfaces for displaying the finance score and a predefined target score.

9. The system of claim 8, further comprising a recommendation unit for providing one or more recommendations to the consumer related to actions to take to reach the predefined target score.

10. The system of claim 8, wherein the recommendation unit is configured to apply one or more machine learning techniques to at least one of the finance score, the creditworthiness data, the consumer related data, and the target asset related data.

11. The system of claim 9, further comprising a confidence scoring unit for applying a confidence value to one or more of the weighted capacity score, the weighted creditworthiness score, and the weighted monetary score.

12. A computer-implemented method for determining a finance score of a consumer, comprising
determining a raw creditworthiness score, a raw monetary score, and a raw capacity score based at least on creditworthiness data, consumer related data, and target asset related data received from one or more data sources,
applying a selected weighted value to the raw creditworthiness score to form a weighted creditworthiness score, to the raw monetary score to form a weighted monetary score, and to the raw capacity score to form a weighted capacity score, and
determining the finance score by arithmetically combining the weighted creditworthiness score, the weighted capacity score and the weighted capacity score.

13. The computer-implemented method of claim 12, wherein the creditworthiness data includes credit score information, further comprising determining the raw creditworthiness score by comparing the credit score information with a threshold credit score associated with a loan product.

14. The computer-implemented method of claim 13, wherein the consumer related data includes monetary information, further comprising determining the raw monetary score by comparing the monetary information with a threshold monetary value of the loan product.

15. The computer-implemented method of claim 14, wherein the consumer related data includes income and debt information associated with the consumer, further comprising determining the raw capacity score by determining a debt-to-income (DTI) ratio of the consumer and comparing the DTI ratio with a threshold DTI ratio of the loan product.

16. The computer-implemented method of claim 15, wherein the selected weighted value associated with the raw monetary score is greater than the selected weighted value associated with the raw creditworthiness score and the selected weighted value associated with the raw capacity score.

17. The computer-implemented method of claim 16, wherein the selected weighted value associated with the raw creditworthiness score is about equal to the selected weighted value associated with the raw capacity score.

18. The computer-implemented method of claim 16, wherein the selected weighted value associated with the raw monetary score is about three times greater than the selected weighted value associated with the raw creditworthiness score and the weighted value associated with the raw capacity score.

19. The computer-implemented method of claim 16, further comprising generating one or more user interfaces for displaying the finance score and a predefined target score.

20. The computer-implemented method of claim 19, further comprising generating one or more recommendations to the consumer related to actions to take to reach the predefined target score.

21. The computer-implemented method of claim 19, applying one or more machine learning techniques to at least one of the finance score, the creditworthiness data, the consumer related data, and the target asset related data.

22. The computer-implemented method of claim 20, further comprising applying a confidence value to one or more of the weighted capacity score, the weighted creditworthiness score, and the weighted monetary score.

23. A non-transitory, computer readable medium comprising computer program instructions tangibly stored on the computer readable medium, wherein the computer program instructions are executable by at least one computer processor to perform a method, the method comprising:
determining a raw creditworthiness score, a raw monetary score, and a raw capacity score based at least on creditworthiness data, consumer related data, and target asset related data received from one or more data sources,
applying a selected weighted value to the raw creditworthiness score to form a weighted creditworthiness score, to the raw monetary score to form a weighted monetary score, and to the raw capacity score to form a weighted capacity score, and
determining the finance score by arithmetically combining the weighted creditworthiness score, the weighted capacity score and the weighted capacity score.

24. The computer readable medium of claim 23, wherein the creditworthiness data includes credit score information, further comprising determining the raw creditworthiness score by comparing the credit score information with a threshold credit score associated with a loan product.

25. The computer readable medium of claim 24, wherein the consumer related data includes monetary information, further comprising determining the raw monetary score by comparing the monetary information with a threshold monetary value of the loan product.

26. The computer readable medium of claim 25, wherein the consumer related data includes income and debt information associated with the consumer, further comprising determining the raw capacity score by determining a debt-to-income (DTI) ratio of the consumer and comparing the DTI ratio with a threshold DTI ratio of the loan product.

27. The computer readable medium of claim 26, wherein the selected weighted value associated with the raw monetary score is greater than the selected weighted value associated with the raw creditworthiness score and the selected weighted value associated with the raw capacity score.

28. The computer readable medium of claim 27, wherein the selected weighted value associated with the raw creditworthiness score is about equal to the selected weighted value associated with the raw capacity score.

29. The computer readable medium of claim 27, wherein the selected weighted value associated with the raw monetary score is about three times greater than the selected weighted value associated with the raw creditworthiness score and the weighted value associated with the raw capacity score.

30. The computer readable medium of claim 27, further comprising generating one or more user interfaces for displaying the finance score and a predefined target score.

31. The computer readable medium of claim 30, further comprising generating one or more recommendations to the consumer related to actions to take to reach the predefined target score.

32. The computer readable medium of claim 30, applying one or more machine learning techniques to at least one of the finance score, the creditworthiness data, the consumer related data, and the target asset related data.

33. The computer readable medium of claim 31, further comprising applying a confidence value to one or more of the weighted capacity score, the weighted creditworthiness score, and the weighted monetary score.
